(19) United States
(12) Patent Application Publication
(10) Pub. No.: US 2025/0368120 A1
(43) Pub. Date: Dec. 4, 2025

(54) SINGLE SNAP-IN MOUNT

(71) Applicant: Ford Global Technologies, LLC, Dearborn, MI (US)

(72) Inventors: Blaise Nugent, Brighton, MI (US); Todd Rakus, Windsor (CA); Stuart C. Salter, White Lake, MI (US); Matthew B. Rutman, Westland, MI (US); Eric Scott Levine, Novi, MI (US); Brendan Diamond, Naples, FL (US)

(21) Appl. No.: 18/677,015

(22) Filed: May 29, 2024

(51) Int. Cl. B60P 7/08

(52) U.S. Cl. CPC B60P 7/0815

(57) ABSTRACT

An assembly includes a base plate with a plurality of apertures and an attachment structure comprising a base body with a plurality of resilient arms coupled to the base body. The base body is associated with an accessory that is attachable to the base plate. Each resilient arm includes at least one snap tab that is selectively moveable between a locked position where the base body is locked to the base plate within a single aperture of the plurality of apertures and an unlocked position wherein the base body is removeable from the base plate.

### TECHNICAL FIELD

This disclosure relates generally to an attachment structure for securement to a base plate in a cargo area, and more particularly, to a single snap-in base body that can be used to secure an accessory to the base plate.

### BACKGROUND

Vehicles transport various types of cargo. A user can, for example, rely on a vehicle to transport accessories, such as containers and tools, to and from a jobsite. The accessories that need to be transported can vary based on the tasks the user performs at the jobsite. Additionally, the accessories can vary in size and shape. Support surfaces in cargo or work areas may be configured to securely support the accessories.

### SUMMARY

In some aspects, the techniques described herein relate to an assembly including: a base plate including a plurality of apertures; and an attachment structure comprising a base body with a plurality of resilient arms coupled to the base body, wherein the base body is associated with an accessory that is attachable to the base plate, and wherein each resilient arm includes at least one snap tab that is selectively moveable between a locked position where the base body is locked to the base plate within a single aperture of the plurality of apertures and an unlocked position wherein the base body is removeable from the base plate.

In a further non-limiting implementation of any of the assemblies, the plurality of resilient arms comprises a pair of resilient arms that are selectively compressible in a direction towards the base body to move from the locked position to the unlocked position.

In a further non-limiting implementation of any of the assemblies, the pair of resilient arms are immediately adjacent to each other relative to the base body.

In a further non-limiting implementation of any of the assemblies, the pair of resilient arms are on opposite sides of the base body from each other.

In a further non-limiting implementation of any of the assemblies, the plurality of apertures comprises a plurality of mounting apertures, a plurality of locking apertures, and a plurality of power interface apertures, and wherein the plurality of apertures are arranged in sub-groups comprised of repeating patterns, and wherein each sub-group includes a plurality of mounting apertures, a plurality of locking apertures, and at least one power interface aperture.

In a further non-limiting implementation of any of the assemblies, the single aperture comprises one of the plurality of locking apertures, and wherein the base body locks the accessory to the base plate.

In a further non-limiting implementation of any of the assemblies, the accessory comprises a flat plate with a plurality of tabs that are insertable into the plurality of mounting apertures, and wherein the flat plate is configured to hold one or more items.

In a further non-limiting implementation of any of the assemblies, the base plate comprises at least a first base plate and a second base plate, and wherein the at least one snap tab comprises a first shoulder formed on each resilient arm, and including at least one second shoulder formed on each resilient arm that is spaced from the first shoulder along a length of each resilient arm, and wherein the first shoulder cooperates with the first base plate comprising a first thickness, and the second shoulder cooperates with the second base plate comprising a second thickness that is less than the first thickness.

In a further non-limiting implementation of any of the assemblies, the single aperture comprises one of the plurality of mounting apertures, and wherein the base body includes an accessory mount interface to which the accessory is selectively attachable.

In a further non-limiting implementation of any of the assemblies, the base body comprises a polygonal shape having at least a first side, a second side opposite of the first side, a third side connecting the first side and second side together, and a fourth side connecting the first side and second side together and which is opposite the third side.

In a further non-limiting implementation of any of the assemblies, the plurality of resilient arms comprises at least a first arm and a second arm that each comprise a first portion extending away from the base body in a first direction and a connecting portion that transitions from the first portion into a second portion that extends in a second direction opposite from the first direction, and wherein the second portion is compressible toward the first portion to move from the locked position to the unlocked position.

In a further non-limiting implementation of any of the assemblies, the at least one snap tab extends outwardly of the second portion in a direction towards an edge of the single aperture.

In a further non-limiting implementation of any of the assemblies, the at least one snap tab comprises at least a first snap tab and a second snap tab that is spaced from the first snap tab, and wherein the first snap tab is engageable with an upper surface of the base plate and the second snap tab is engageable with a lower surface of the base plate.

In a further non-limiting implementation of any of the assemblies, the first arm is on the first side and the second arm is on one of the third side and the fourth side, and including walls that extend from each of the second side and the other of the third side and the fourth side, wherein each wall extends in the first direction and terminates at a transversely extending flange that abuts against an edge of the single aperture.

In a further non-limiting implementation of any of the assemblies, the first arm is on the first side and the second arm is on the second side, and including walls that extend from each of the third side and the fourth side, wherein each wall extends in the first direction and terminates at a transversely extending flange that abuts against an edge of the single aperture.

In a further non-limiting implementation of any of the assemblies, a first wall and a second wall extend away from the base body in the first direction, and wherein the first arm, the second arm, the first wall, and the second wall are circumferentially separated from each other by open gaps.

In some aspects, the techniques described herein relate to a method comprising: providing a base plate with a plurality of mounting apertures, a plurality of lock apertures that are separate from the plurality of mounting apertures, and a plurality of power interface apertures that are separate from the plurality of lock apertures and the plurality of mounting apertures; forming an attachment structure to comprise a base body with a plurality of resilient arms coupled to the base body, wherein the base body is associated with an accessory that is attachable to the base plate, and wherein each resilient arm includes at least one snap tab; and selectively moving the at least one snap tab between a locked position where the base body is locked within a single aperture of the plurality of mounting apertures and an unlocked position wherein the base body is removeable from the base plate.

In a further non-limiting implementation of any of the methods, the plurality of resilient arms comprises a pair of resilient arms, and including selectively compressing the pair of resilient arms in a direction towards the base body to move from the locked position to the unlocked position.

In a further non-limiting implementation of any of the methods, the method includes locating the pair of resilient arms immediately adjacent to each other relative to the base body, or locating the pair of resilient arms on opposite sides of the base body from each other.

In a further non-limiting implementation of any of the methods, the single aperture comprises one of the plurality of locking apertures, and wherein the base body locks the accessory to the base plate; or the single aperture comprises one of the plurality of mounting apertures, and wherein the base body includes an accessory mount interface to which the accessory is selectively attachable.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1A illustrates a perspective view of a vehicle having a cargo bed equipped with base plates that can be used to secure an accessory according to an exemplary aspect of the present disclosure.

FIG. 1B illustrates a perspective view of a van having a cargo area equipped with base plates that can be used to secure accessories according to an exemplary aspect of the present disclosure.

FIG. 2A is a perspective view of one example of an attachment structure for a base plate.

FIG. 2B is a top view of the attachment structure of FIG. 2A as attached to a base plate.

FIG. 2C is a bottom view of FIG. 2B.

FIG. 3 is a top perspective view of a mounting hole configuration.

FIG. 4A is a perspective view of another example of an attachment structure for a base plate.

FIG. 4B is a top view of the attachment structure of FIG. 4A as attached to a base plate.

FIG. 4C is a bottom view of FIG. 4B.

FIG. 5 is a perspective view of another example of an attachment structure for a base plate.

FIG. 6 is a front perspective view of one example of an accessory.

FIG. 7 is a rear view of the accessory of FIG. 6 as attached to the base plate.

FIG. 8 is a perspective view of another example of an attachment structure for attaching the accessory of FIG. 6 to the base plate.

### DETAILED DESCRIPTION

The subject disclosure provides a base plate including a plurality of apertures and an attachment structure comprising a base body with a plurality of resilient arms coupled to the base body. The base body is associated with an accessory that is attachable to the base plate, and each resilient arm includes at least one snap tab that is selectively moveable between a locked position where the base body is locked to the base plate within a single aperture of the plurality of apertures and an unlocked position wherein the base body is removeable from the base plate The attachment structure for an accessory can be quickly and easily attached/detached without the use of tools.

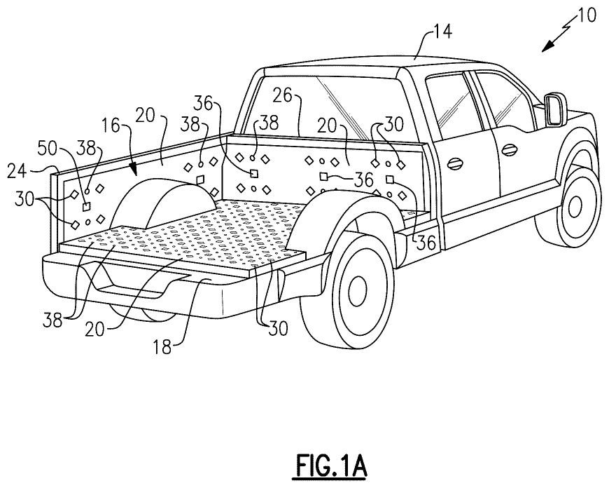

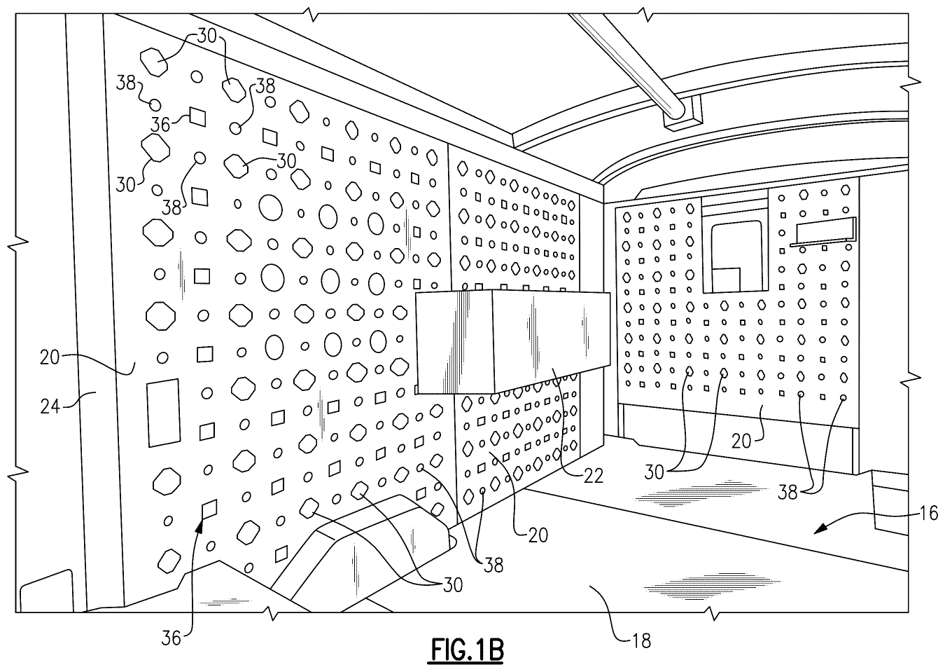

In one example, an attachment system for accessories is used on a vehicle. With reference to FIGS. 1A and 1B, a vehicle 10 includes a passenger compartment 14 and a cargo area 16 that is aft of the passenger compartment 14. The cargo area 16 has a floor 18. In this example, the vehicle 10 is a pickup truck. However, the vehicle 10 could be another type of vehicle in another example, such as a car, van, sport utility vehicle, etc. FIG. 1B shows an example of a van that incorporates a base plate 20 with an accessory attachment system.

In the exemplary embodiment, one or more base plates 20 are used to support one or more accessories and/or modules 22. In one example, the cargo bed 16 is defined by a pair of side walls 24 (only one is shown in FIG. 1A for purposes of clarity), a rear wall 26, and a tailgate (not shown). In one example, the base plates 20 are secured directly to walls 24, 26 and/or to the floor 18 of the cargo area 16 by fastening, welding, etc., at a first connection interface. The accessories and/or modules 22 can be secured to the vehicle 10 by engaging one or more of the base plates 20 via a second connection interface separate from the first connection interface.

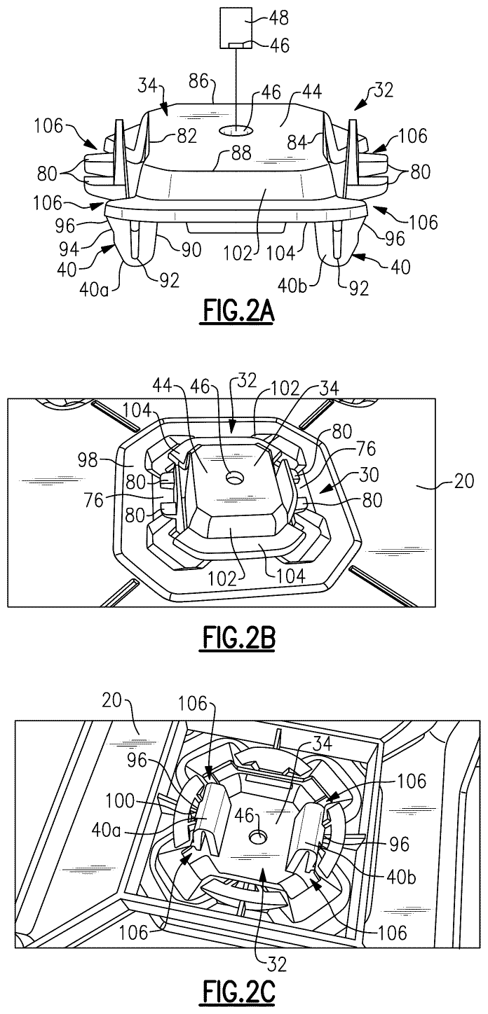

As shown in FIGS. 1A-1B, the base plates 20 include a plurality of mounting openings or apertures 30. In one example as shown in FIGS. 2A-2C, an example attachment structure 32 comprises a base body 34 that includes a plurality of resilient arms 40. The attachment structure 32 can engage the base plate 20 by inserting the resilient arms 40 into a single mounting aperture 30 to provide a mechanical connection interface. The apertures 30 are spaced upwardly from the floor 18 or side wall 24, 26 by an open gap such that the resilient arms 40 from the attachment structure 32 can be easily inserted into the base plate 20. In one example, the accessories 22 as shown in FIG. 1B may include feet that extend outward of the accessory and are received within mounting apertures 30 in the base plate 20. In other implementations, the accessory 22 can be selectively secured to the base body 34 of the attachment structure 32 to attach the accessory 22 to the base plate 20, or the base body 34 can be used to secure the accessory 22 to the base plate 20. In one example, the accessory 22 can then be removed from the base body 34 as needed by compressing the resilient arms 40 to remove the base body 34 from the base plate 20.

As discussed above, the base plates 20 with the mounting apertures 30 can be mounted to the walls 24, 26 or the floor 18 in the cargo area 16. In one example, the base plate 20 also includes other openings or apertures 36 (FIGS. 1A-1B) for a power connection interface (to connect accessories to a power source for power supply, recharging, etc.), and further includes additional openings or locking apertures 38 for a locking feature that allows the base body 34 to be securely locked to the base plate 20. The power apertures 36 and locking apertures 38 are spaced apart and separate from each other and from the mounting apertures 30. In one example, the apertures 30, 36, 38 can have shapes and/or sizes that are different from each other. These sets of apertures 30, 36, 38 are provided at multiple locations on the base plate 20, and are formed in sub-groups that comprise a desired/specified repeating pattern on the base plate 20 to allow for the base bodies 34 to be mounted in various different locations as needed. In one example, the mounting apertures 30 are formed to have a diamond shape and are larger in size than the power apertures 36 and locking apertures 38.

In one example, the mounting apertures 30 in each sub-group are formed in a four corner pattern with a center power aperture 36 between the four corners, and with locking apertures 38 between adjacent mounting apertures 30. This pattern provides for easy and quick connect/disconnect and can be repeated across the base plate 20 as many times as allowed per size of the base plate 20.

In the example shown in FIGS. 2A-2C, the base body 34 includes a base surface 44 with at least one attachment interface 46 that cooperates with an accessory or support member 48 to hold the one or more items or accessories 22. In one example, the attachment interface 46 comprises a fastener attachment; however, other attachment interfaces could also be used, such as snap-fit for example. In one example, the support member 48 can comprise a loop structure, cup holder, camera grip, smart device holder, etc.

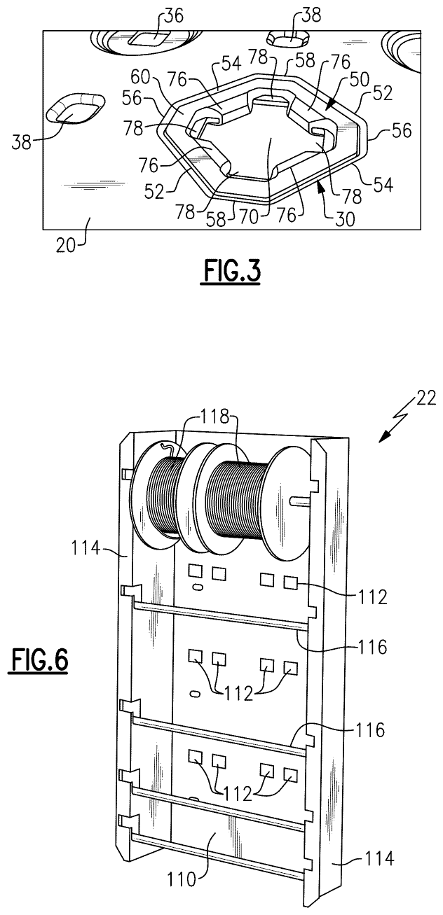

As discussed above, the attachment structure 32 includes the base body 34 with a plurality of circumferentially spaced resilient arms 40. In one example, the plurality of resilient arms 40 are configured to be received within one single, diamond-shaped, mounting aperture 30 of the base plate 20 in a resilient manner. An example of the configuration of the diamond-shaped mounting apertures 30 is shown in FIG. 3.

In implementations, each mounting aperture 30 may include an insert 50. The insert 50 can facilitate insertion of the base body 34 into the apertures 30.

In this example, the diamond-shaped mounting aperture 30 is defined by a plurality of straight and linear segments. In one example, each polygonal shape has at least eight linear segments. As shown in FIG. 3, the mounting aperture 30 is defined by a first pair of edges 52 that are parallel and opposite of each other and a second pair of edges 54 that are parallel and opposite of each other. The mounting aperture 30 is further defined by a third pair of edges 56 that are parallel and opposite of each other and a fourth pair of edges 58 that are parallel and opposite of each other. The third 56 and fourth 58 pairs of edges are shorter than the first 52 and second 54 pairs of edges and are used to connect the first 52 and second 54 pairs of edges to each other as shown in FIG. 3. The intersections between ends of the third 56 and fourth 58 pairs of edges and ends of the first 52 and second 54 pairs of edges are at a non-perpendicular angle. The longer first 52 and second 54 pairs of edges in combination with the non-perpendicular intersections provide the mounting apertures 30 with an overall diamond shape.

In one example, the insert 50 comprises an outer peripheral surface that is defined by a polygonal shape. In one example, the insert 50 is configured to mimic or match the diamond shape of the mounting aperture 30. In one example, the polygonal shape of the insert 50 has at least eight linear segments that generally correspond to the segments for the diamond shape of the mounting aperture 30. In one example, a flat upper body portion 60 of the insert 50 includes a central opening 70 that aligns with the mounting aperture 30 when the insert 50 is installed on the base plate 20. The flat upper body portion 60 is defined by an outer peripheral surface that defines the polygonal shape and an inner peripheral surface that defines the opening 70. In one example, a plurality of hinges 76 are formed about the inner peripheral surface 74. In one example, an enlarged opening 78 is formed in the upper body portion 60 at each corner between adjacent hinges 76. The plurality of hinges 76 can comprise living hinges, for example. The living hinges are integrally formed with the insert 50 such that they can bend back and forth about a hinge point at the inner peripheral surface. When installed in the mounting apertures 30 as shown in FIG. 3, the hinges 76 are bent around edges of the apertures 30.

In the example shown in FIGS. 2A-2C, each resilient arm 40 includes at least one snap tab 80 that is selectively moveable between a locked position where the base body 34 is locked to the base plate 20 within a single aperture of the plurality of apertures and an unlocked position wherein the base body 34 is removeable from the base plate 20. In implementations, the single aperture comprises one of the diamond-shaped mounting apertures 30 as shown in FIG. 3.

In implementations, the plurality of resilient arms 40 comprises a pair of resilient arms 40a, 40b that are selectively compressible in a direction towards the base body 34 to move from the locked position to the unlocked position.

In the example of FIGS. 2A-2C, the pair of resilient arms 40a, 40b are on opposite sides of the base body 34 from each other.

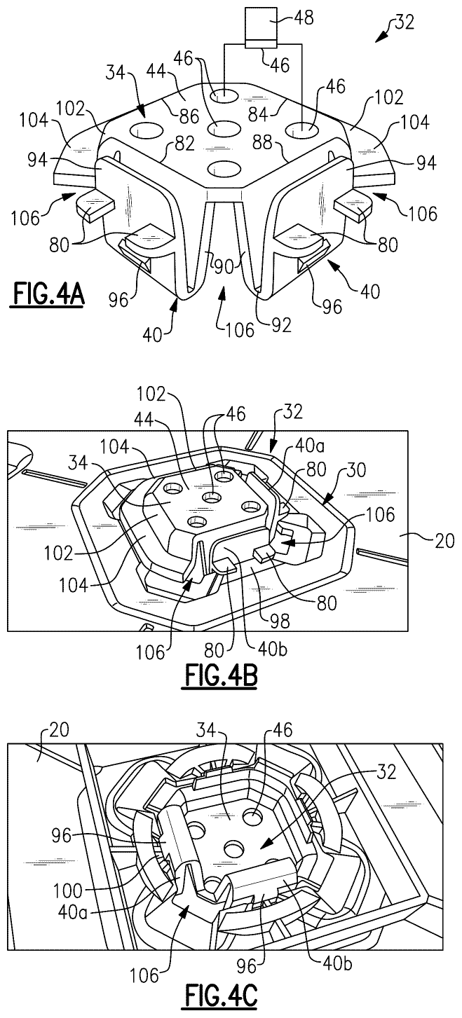

In the example of FIGS. 4A-4C, the pair of resilient arms 40a, 40b are immediately adjacent to each other relative to the base body 34.

In each example, the base body 34 comprises a polygonal shape having at least a first side 82, a second side 84 opposite of the first side 82, a third side 86 connecting the first side 82 and second side 84 together, and a fourth side 88 connecting the first side 82 and the second side 84 together, and which is opposite the third side 86.

Further, in each example, the plurality of resilient arms 40 comprises at least a first arm 40a and a second arm 40a that each comprise a first portion 90 extending away from the base body 34 in a first direction and a connecting portion 92 that transitions from the first portion 90 into a second portion 94 that extends in a second direction opposite from the first direction. In implementations, the second portion 94 is compressible toward the first portion 90 to move from the locked position to the unlocked position.

In one example, the snap tab 80 extends outwardly of the second portion 94 in a direction towards edges of the single aperture 30 as shown in FIG. 2B. In this example, the at least one snap tab 80 comprises at least two snap tabs 80. In this example, each snap tab 80 directly engages the edge of the single aperture 30 which may comprise one of the hinges 76. In this example, the snap tabs 80 engage an upper surface of the hinges 76. Optionally, if the mounting aperture 30 does not include an insert 50, the snap tabs 80 directly engage edges of the aperture 30. In one example, edges of the aperture may correspond in shape to the profile of the insert.

In implementations, each resilient arm 80 may include additional snap tabs. For example, in addition to the first snap tabs 80, an additional or second snap tab 96 can be formed on each resilient arm 40. In one example, the second snap tab 96 is spaced from the first snap tab 80 in a direction along a length of the arms 40. In implementations, the first snap tabs 80 are engageable with an upper surface 98 of the base plate 20 or insert 50 as shown in FIG. 2B and the second snap tab 96 is engageable with a lower surface 100 of the base plate or insert 50 as shown in FIG. 2C.

The example of FIGS. 4A-4C the resilient arms 40a, 40b also include first snap tabs 80 and second snap tabs 96 in a manner similar to that of FIGS. 2A-2C. As discussed above, the pair of resilient arms 40a, 40b of FIGS. 2A-2C are on opposite sides of the base body 34 from each other, while the pair of resilient arms 40a, 40b are immediately adjacent to each other in FIGS. 4A-4C.

Further, in the example of FIGS. 2A-2C, the first arm 40a is on the first side 82 of the base body 34 and the second arm 40b is on the second side 84. In this example, walls 102 extend from each of the third side 86 and the fourth side 88, wherein each wall 102 extends in the same direction as the first portion 90 of each arm 40a, 40b and terminates at a transversely extending flange 104 that abuts against an edge of the single aperture 30 as shown in FIG. 2B. In one example, the flanges 104 overlap an upper surface of the insert 50 or the upper surface 98 of the base plate 20 along an entire length of the third side 86 and the fourth side 88 to provide for increased support.

Further, in the example of FIGS. 4A-2C, the first arm 40a is on the first side 82 and the second arm 40a is on one of the third side 86 and the fourth side 88. In the example shown in FIG. 4A, the second arm 40a is on the fourth side 88, and walls 102 extend from each of the second side 84 and the third side 86. Each wall 102 extends in the same direction as the first portion 90 of each arm 40a, 40b and terminates at the transversely extending flange 104 that abuts against an edge of the single aperture 30. In one example, the flanges 104 overlap an upper surface of the insert 50 or the upper surface 98 of the base plate 20 along an entire length of the third side 86 and the second side 84 to provide for increased support.

In both examples, in implementations, the first arm 40a, the second arm 40b, and each of the walls 102 are circumferentially separated from each other by open gaps 106 as best shown in FIGS. 2C and 4C.

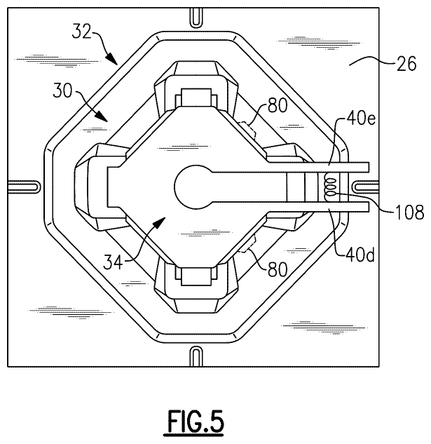

FIG. 5 shows another example of an attachment structure 32 that comprises a base body 34 that includes a plurality of resilient arms 40c, 40d. In this example, the resilient arms 40c, 40d extend outwardly from a common corner of the base body 34 and comprise lever arms that are compressed together to move from the locked position to the unlocked position. Sides of the base body 34 include snap tabs 80 that fit under edges of the insert or base plate 20. In implementations, a resilient member 108, e.g., a spring, can be mounted between the arms 40c, 40d to bias the snap tabs 80 to the locked position.

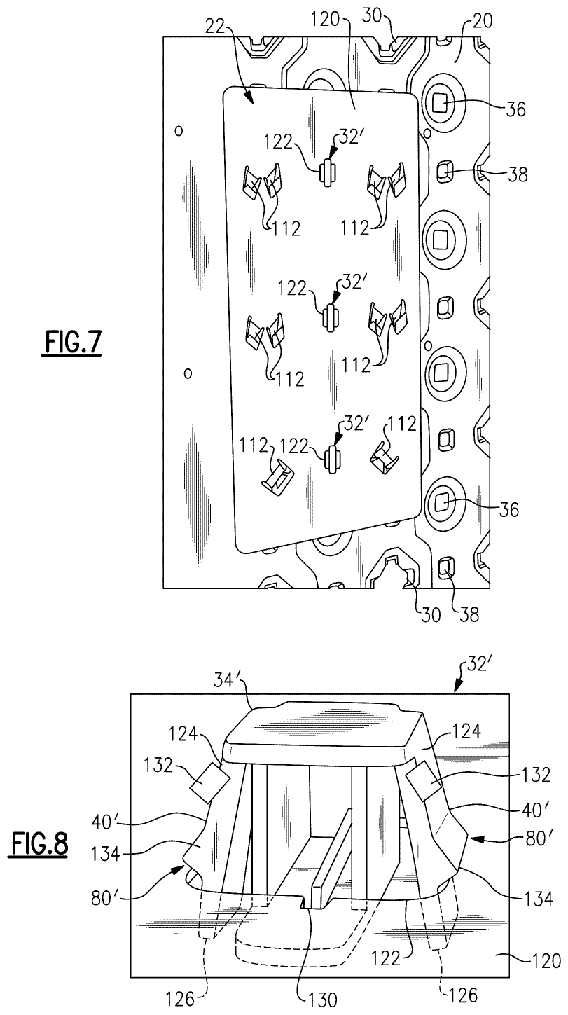

In another example shown in FIG. 6, the accessory 22 comprises a tool support that is mechanically coupled to the vehicle 10 via the base plate 20. In this example, the accessory 22 includes a base surface or primary surface 110 that includes a plurality of mounting extensions 112. The accessory 22 further includes a secondary surface 114 providing a support structure 116 to hold one or more items 118. In one example, the mounting extensions 112 comprise tabs that are bent outwardly of the primary surface 110 and received within selected mounting apertures 30 as shown in FIG. 7.

In one example, the primary surface 110 of the accessory 22 comprises a sheet metal, flat plate body 120 as shown in FIGS. 6-7. The secondary surface 114 and support structure 116 of the accessory 22 are not shown in FIG. 7 for purposes of clarity. In one example, the tabs 112 are integrally formed with the sheet metal plate body 120, with each tab 112 comprising a base formed with the sheet metal plate body 120 and extending to a distal end that is free from contact with the sheet metal plate body 120. The tabs 112 are inserted into the mounting apertures 30 to attach the accessory 22 to the base plate 20.

In implementations, an attachment structure 32′ that comprises a base body 34′ with resilient arms 40′ is used to secure/lock the accessory 22 to the base plate 20. In one example, the attachment structure 32′ is received within a single lock aperture 38 spaced from the plurality of mounting apertures 30. In one example, the lock aperture 38 has a different size and/or shape than the plurality of mounting apertures 30. In the example shown, the lock aperture 38 is smaller in size than the mounting aperture 30.

In one example, the primary surface 110 of the accessory 22 includes one or more insert openings 122 that are located between sets of the tabs 112. In one example, the primary surface 110 includes multiple insert openings 122 that extend along a center line of the plate body 120. In implementations, the attachment structure 32′ can either be inserted into the insert openings 122, or the attachment structure 32′ can be permanently fixed, e.g. molded, to the primary surface 110.

In one example shown in FIG. 8, the resilient arms 40′ that are selectively moveable between an installed/locked position and an uninstalled/unlocked position. Each arm 40′ has a base end 124 formed with the base body 34′ and extends to a distal end 126 that is spaced from the base body 34′. Each arm 40′ also includes at least one snap tab 80′ facing outwardly of the arm 40′ at a location between base end 124 and the distal end 126. To lock the accessory 22 to the plate body 120, the distal ends 126 of the arms 40′ are squeezed or compressed towards each other such that the base body 34′ and snap 80′ can be slid through the insert opening 122. Once the snap tabs 80′ clear the opening 122, the arms 40′ are released and the snap tabs 80 engage a lower surface of the plate body 120.

In one example, the plate 120 includes one or more locating features 130 to facilitate positioning of the attachment structure 32′ in the insert openings 122. In implementations, the locating feature 130 comprises a slot or groove formed in an edge of the lock aperture 38. In one example, a protrusion from the base body 34′ is located within the slot.

In one example, the base plate 20 comprises at least a first base plate and a second base plate that have different thicknesses. In implementations, the at least one snap tab 80′ comprises a first shoulder 132 formed on each resilient arm 40′ and at least one second shoulder 134 formed on each resilient arm 40′ that is spaced from the first shoulder 132 along a length of each resilient arm 40′. The first shoulder 132 cooperates with the first base plate comprising a first thickness, and the second shoulder 134 cooperates with the second base plate comprising a second thickness that is less than the first thickness. Thus, for this example configuration, the attachment structure 32′ can have multiple snap tabs/shoulders at different levels/heights such that different thickness for base plates can be accommodated. Additionally, using this feature, the attachment structure 32′ has additional robustness in case one tab/shoulder should become unusable, the other one can be used.

In one example, the attachment structures are molded from polypropylene with 30% to 50% glass fiber filler; however, for heavier load applications graphite fibers can be used. Optionally, a dual shot process with glass fiber or graphite filler only on an attachment surface can be utilized.

Additionally, in implementations to enhance seeing the features of the attachment structures a long persistence phosphor material can be molded in the attachment structures that emits glowing color such as green, for example.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. An assembly, comprising:
a base plate including a plurality of apertures; and
an attachment structure comprising a base body with a plurality of resilient arms coupled to the base body, wherein the base body is associated with an accessory that is attachable to the base plate, and wherein each resilient arm includes at least one snap tab that is selectively moveable between a locked position where the base body is locked to the base plate within a single aperture of the plurality of apertures and an unlocked position wherein the base body is removeable from the base plate.

2. The assembly of claim 1, wherein the plurality of resilient arms comprises a pair of resilient arms that are selectively compressible in a direction towards the base body to move from the locked position to the unlocked position.

3. The assembly of claim 2, wherein the pair of resilient arms are immediately adjacent to each other relative to the base body.

4. The assembly of claim 2, wherein the pair of resilient arms are on opposite sides of the base body from each other.

5. The assembly of claim 1, wherein the plurality of apertures comprises a plurality of mounting apertures, a plurality of locking apertures, and a plurality of power interface apertures, and wherein the plurality of apertures are arranged in sub-groups comprised of repeating patterns, and wherein each sub-group includes a plurality of mounting apertures, a plurality of locking apertures, and at least one power interface aperture.

6. The assembly of claim 5, wherein the single aperture comprises one of the plurality of locking apertures, and wherein the base body locks the accessory to the base plate.

7. The assembly of claim 6, wherein the accessory comprises a flat plate with a plurality of tabs that are insertable into the plurality of mounting apertures, and wherein the flat plate is configured to hold one or more items.

8. The assembly of claim 6, wherein the base plate comprises at least a first base plate and a second base plate, and wherein the at least one snap tab comprises a first shoulder formed on each resilient arm, and including at least one second shoulder formed on each resilient arm that is spaced from the first shoulder along a length of each resilient arm, and wherein the first shoulder cooperates with the first base plate comprising a first thickness, and the second shoulder cooperates with the second base plate comprising a second thickness that is less than the first thickness.

9. The assembly of claim 5, wherein the single aperture comprises one of the plurality of mounting apertures, and wherein the base body includes an accessory mount interface to which the accessory is selectively attachable.

10. The assembly of claim 5, wherein the base body comprises a polygonal shape having at least a first side, a second side opposite of the first side, a third side connecting the first side and second side together, and a fourth side connecting the first side and second side together and which is opposite the third side.

11. The assembly of claim 10, wherein the plurality of resilient arms comprises at least a first arm and a second arm that each comprise a first portion extending away from the base body in a first direction and a connecting portion that transitions from the first portion into a second portion that extends in a second direction opposite from the first direction, and wherein the second portion is compressible toward the first portion to move from the locked position to the unlocked position.

12. The assembly of claim 11, wherein the at least one snap tab extends outwardly of the second portion in a direction towards an edge of the single aperture.

13. The assembly of claim 11, wherein the at least one snap tab comprises at least a first snap tab and a second snap tab that is spaced from the first snap tab, and wherein the first snap tab is engageable with an upper surface of the base plate and the second snap tab is engageable with a lower surface of the base plate.

14. The assembly of claim 11, wherein the first arm is on the first side and the second arm is on one of the third side and the fourth side, and including walls that extend from each of the second side and the other of the third side and the fourth side, wherein each wall extends in the first direction and terminates at a transversely extending flange that abuts against an edge of the single aperture.

15. The assembly of claim 11, wherein the first arm is on the first side and the second arm is on the second side, and including walls that extend from each of the third side and the fourth side, wherein each wall extends in the first direction and terminates at a transversely extending flange that abuts against an edge of the single aperture.

16. The assembly of claim 11, including a first wall and a second wall that extend away from the base body in the first direction, and wherein the first arm, the second arm, the first wall, and the second wall are circumferentially separated from each other by open gaps.

17. A method comprising:
providing a base plate with a plurality of mounting apertures, a plurality of lock apertures that are separate from the plurality of mounting apertures, and a plurality of power interface apertures that are separate from the plurality of lock apertures and the plurality of mounting apertures;
forming an attachment structure to comprise a base body with a plurality of resilient arms coupled to the base body, wherein the base body is associated with an accessory that is attachable to the base plate, and wherein each resilient arm includes at least one snap tab; and
selectively moving the at least one snap tab between a locked position where the base body is locked within a single aperture of the plurality of mounting apertures and an unlocked position wherein the base body is removeable from the base plate.

18. The method of claim 17, wherein the plurality of resilient arms comprises a pair of resilient arms, and including selectively compressing the pair of resilient arms in a direction towards the base body to move from the locked position to the unlocked position.

19. The method of claim 18, including locating the pair of resilient arms immediately adjacent to each other relative to the base body, or locating the pair of resilient arms on opposite sides of the base body from each other.

20. The method of claim 17, wherein:
the single aperture comprises one of the plurality of lock apertures, and wherein the base body locks the accessory to the base plate; or
wherein the single aperture comprises one of the plurality of mounting apertures, and wherein the base body includes an accessory mount interface to which the accessory is selectively attachable.
